(19) United States
(12) Patent Application Publication
(10) Pub. No.: US 2016/0129655 A1
(43) Pub. Date: May 12, 2016

(54) APPARATUS FOR SEPARATING A LIQUID PRODUCT FROM A PACKAGE CONTAINING THE LIQUID PRODUCT

(71) Applicant: FLUIDOR EQUIPMENT B.V., Raamsdonksveer (NL)

(72) Inventor: Robbert Christianus Antonius WOUTERS, Raamsdonksveer (NL)

(21) Appl. No.: 14/934,322

(22) Filed: Nov. 6, 2015

(30) Foreign Application Priority Data
Nov. 7, 2014 (NL) 2013757

(51) Int. Cl. B30B 9/20; B30B 15/30; B30B 3/06

(52) U.S. Cl. CPC B30B 9/207; B30B 3/06; B30B 15/30

(57) ABSTRACT

An apparatus for separating liquid product from a package containing the liquid product, including a rotary press including a rotatable drum and an eccentrically placed roller at a lower part within the rotatable drum. The apparatus has a capturing space between the rotary drum and the roller, being defined by a narrowing distance between a roller outer surface and a rotary drum inner surface in a rotation direction of the rotary press for receiving, capturing and pressing the package containing liquid product. The apparatus further has a releasing space between the rotary drum and the roller, being defined by a widening space between the roller outer surface and the rotary drum inner surface in the rotation direction of the rotary press for releasing the pressed package. The roller and the rotatable drum are cooperatively positioned to form a liquid barrier at a contact line between the outer surface of the roller and the inner surface of the rotatable drum. The apparatus further has a baffle placed between the roller and the rotatable drum for separating the capturing space and the releasing space for preventing liquid product pressed from the package to enter the releasing space.

### FIELD OF THE INVENTION

The invention relates to an apparatus for separating liquid product from a package containing the liquid product.

### BACKGROUND OF THE INVENTION

It is commonly known that liquid products like milk or fruit juice with relative low viscosity, and other products such as butter, tomato paste and the like with a higher viscosity, are sold or stored in disposable packages such as cartons, liquid resistant foil, plastic containers or paper. The same liquid products may also be available in containers with various dimensions and shapes for selling in small quantities and attractive presentations. Such liquid products however can have a limited shelf life.

When a stock of such liquid products has outdated its shelf life, the product is to be removed from the shelf or stock and destroyed for hygienic purposes and/or for recycling of the product. Also the package and its composing materials may be destroyed or recycled. In order to achieve the destruction and/or recycling, liquid product and its package in which it is contained must be separated. Separation of the packaged liquid product can be a labour intensive process requiring manual intervention such as cutting packages. The outdated liquid product is to be removed from the package containing the liquid product such that the separated liquid product and package can be processed and disposed of through separate routes. Each route has its own hygienic or sanitary standards. Following such routes the released product and/or package is subjected to decay. Bacterial and fungus may grow easily in an environment wherein the perishable liquid product is separated from the package.

### SUMMARY OF THE INVENTION

It is an object of the invention to overcome the above stated problems.

The object is achieved in an apparatus for separating liquid product from a package containing the liquid product, comprising a rotary press comprising a rotatable drum and an eccentrically placed roller at a lower part within the rotatable drum, the rotary press having a first end and an opposite end. The rotary press has a capturing space between the rotary drum and the roller, being defined by a narrowing distance between a roller outer surface and a rotary drum inner surface in a rotation direction of the rotary press for receiving, capturing and pressing the package containing liquid product.

The rotary press further has a releasing space between the rotary drum and the roller, being defined by a widening space between the roller outer surface and the rotary drum inner surface in the rotation direction of the rotary press for releasing the pressed package. The roller and the rotatable drum are cooperatively positioned to form a liquid barrier at a contact line between the outer surface of the roller and the inner surface of the rotatable drum. The apparatus further has a first baffle placed between the roller and the rotatable drum for separating the capturing space and the releasing space for preventing liquid product pressed from the package to enter the releasing space.

When in operation a package containing liquid product is inserted in the capturing space between drum and roller, it will be captured between the inner surface of the drum and the outer surface of the roller and pressed between the drum and roller by the rotating motion of the press. In the progressing rotational movement the distance between roller outer surface and drum inner surface is reduced so pressure is exerted on the package. When the pressure within the package is high enough the package will burst and the liquid product is released. As the rotation progresses, the package will be squeezed and flattened as it passes through the nip, the contact line between roller and rotatable drum. The package will eventually be released in the releasing space after the contact line. The contact line i.e. liquid barrier keeps the released liquid product which was pressed out of the package in the capturing space. The liquid product can flow out of the press by gravitational force. The flattened package can also drop out of the releasing space by gravitational force.

Thus the liquid barrier and first baffle together enable hygienic processing of packages containing liquid product ensuring that released liquid product and package are kept separate.

The apparatus further has a first cover or first cover means located at the opposite end of the rotary press. A first seal is arranged between the rotatable drum and the first cover means allowing the rotary press to rotate while the first cover means is stationary. The first cover means has a first output or first output means for allowing the liquid product to be drained from the capturing space into the first output means, and a second output or second output means for allowing the package to be discharged from the releasing space.

This allows further clean and hygienic processing of packages containing liquid products, preventing released liquid product to leave the rotary press and pollute the environment surrounding the apparatus according to the invention. The first and second output means provide separated clean and hygienic discharge of the liquid and squeezed packages respectively.

In an embodiment, the apparatus comprises a second cover or second cover means at the first end of the press, having a second seal between the rotatable drum and the second cover means allowing the rotary press to rotate while the second cover means is stationary. The second cover means has an opening for allowing the package containing liquid product to be fed into the capturing space via the input or input means. The second cover means prevents liquid product squeezed from the package to leak or spray from the capturing space to the environment at the first end of the rotary press.

In an embodiment, the first baffle extends from the second cover means to the first cover means thereby improving the separation between capturing space and releasing space.

In an embodiment, the first baffle is provided with scraping or scraping means arranged for scraping liquid product from a side of the roller at the opposite end of the rotary press. This keeps the roller side at the low end of the rotary press free from liquid product, thus further improving clean and hygienic operation of the apparatus.

In an embodiment, the first and/or first cover means are provided with spray heads for spraying a cleansing agent into the rotary press. This allows cleansing of the apparatus without having to disassemble the apparatus to clean up for new batches of packaged products.

In an embodiment the apparatus can have input means at the first end of the press for feeding the package containing liquid product into the capturing space. The input means can be connected to the opening of the second cover means. The input means provide safe or safe means for inputting packages filled with liquid product, preventing accidental operator access to the rotary press.

In an embodiment the input means comprises a funnel shaped channel, allowing easy and safe access for an operator to the rotary press. The funnel shaped or tapered channel is provided with a length and length to diameter ratio sufficient for safe access for packages containing liquid product and for preventing spraying out of the input means to the apparatus environment.

In an embodiment, a second baffle is disposed in the first cover means for separating the first and second output means. This further separates the liquid product from the packages released from the rotary press.

In an embodiment, the apparatus has a guide within the capturing space for guiding the package containing liquid product into the capturing space. This ensures reliable operation of the apparatus and allows packages containing liquid product to be captured in the centre part of the rotary press.

In an embodiment, the rotary press is held at an angle between a rotation axis of the rotary press and a horizontal plane, wherein the first end of the press is in a higher position relative to the horizontal plane than the opposite end. This allows liquid product to flow out of the rotary press at a lower end, and also allows flattened packages to be released at the lower end of the rotary press from the releasing space.

In an embodiment, the apparatus comprises a drive for driving at least one of the rotatable drum and the roller in the rotation direction. Preferably the roller is driven, however alternatively the rotatable drum may also be driven. In the preferred embodiment, the drive is coupled to the roller with an axle, wherein the axle extends through the second cover means and the first cover means with bearings each having a respective third seal, to prevent liquid product from exiting the apparatus, while simultaneously preventing any ingress of materials into the apparatus from the bearing or from the environment. This allows the drive parts that need lubrication to be kept away from the released liquid product. Thus the released captured product can be kept in a hygienic state, advantageously allowing the recycling of the released product.

In an embodiment, the outer surface of the roller and/or the inner surface of the rotatable drum is lined with a layer of resilient material. This allows packages having hard or less flexible component to be flattened without losing the liquid barrier at the contact line between the roller and the rotatable drum. When flattened package passes through the contact line, hard parts of the package will impress the respective linings of the roller and rotatable drum, while the liquid barrier in other places along the contact line is maintained.

In a preferred embodiment, the resilient material is made of rubber.

### BRIEF DESCRIPTION OF THE DRAWINGS

FIG. 1 shows a diagram of apparatus for separating liquid product from a package containing the liquid product according to embodiment of the invention.

FIG. 2 shows a cross section along the line A-A′ of the apparatus according to FIG. 1.

FIG. 3 shows a cross section of the apparatus according to FIGS. 1 and 2 in an axial direction of the apparatus according to FIG. 1.

FIG. 4a shows a detail of the apparatus according to an embodiment of the invention.

FIG. 4b shows another detail of the apparatus according to an embodiment of the invention.

### DETAILED DESCRIPTION OF EMBODIMENTS OF THE INVENTION

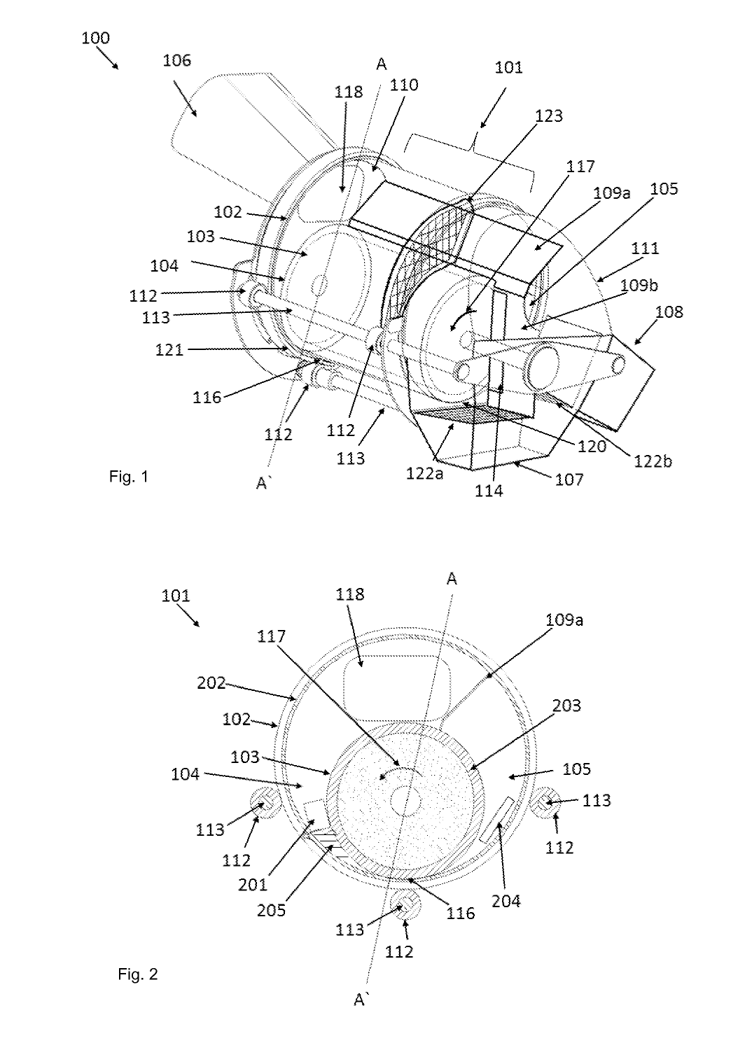

FIG. 1 shows an apparatus for the separation of liquid from a package, comprising a rotary press 101. The rotary press 101 has rotatable drum 102 and a roller 103 which are aligned to form contact line 116 between the roller 103 and in a surface of the drum 102. The rotary press 101 is arranged to be driven in a single rotation direction 117. The rotary press 101 is preferably driven by driving the roller 103. As the roller 103 has a contact line 116 with an inner side of the rotatable drum, the drum is also driven in the same rotation direction 117. Alternatively the rotary press 101 can be driven by driving the rotary drum 102 directly. This is not further disclosed in this application, A skilled person will know by which means the rotary drum 102 can be driven directly. The rotatable drum 102 is supported by plurality of support wheels 112 which are mounted on support axles 113 allowing the rotary press to rotate and be supported simultaneously. The support axles 113 are further mounted to a support frame or mount, not shown in the drawings.

By the placement of the roller 103 eccentrically with respect to a central rotation axis of the drum 102, a capturing space to 104 is defined by the space between roller 103 and drum 102 where the distance between upper surface of the in a surface of the drum 102 is narrowing in the rotation direction 117 of the rotary press 101. Likewise a releasing space 105 is defined by a widening distance between the roller surface and the drum inner surface in the rotation direction 117.

By inserting a package containing liquid product into the capturing space 104, in operation i.e. with the rotary press 101 rotating into the rotation direction 117, a package containing liquid product will be captured between the roller 103 and rotatable drum 102. When captured, the package containing liquid product will be entrained between roller 103 and rotatable drum 102 and eventually flattened caused by rotational movement of the rotary press 101 and subsequent narrowing distance between roller 103 and rotatable drum 102. By pressing and flattening the package containing liquid product, and the liquid product not being compressible, the package will burst and release the liquid product into the capturing space 104. Under the influence of gravity the released liquid product will flow out of the rotatable drum and can be captured in a drain 107.

The contact line 116 between the outer surface of the roller 103 and inner surface of the rotatable drum 102 prevents the liquid product from flowing in to the releasing space 105 and thus forms a liquid barrier. The package relieved of the liquid product is ultimately fed into, the releasing space by the rotational motion 117 of the rotary press 101.

In order to facilitated rapid draining of the released liquid product from the rotary press 101, the apparatus can be tilted with respect to a horizontal plane. The released liquid product will flow to the lower opposite end 120.

The flattened package can be removed from the releasing space 105. This can be performed by allowing the package to drop out of the rotatable drum 102 into a package discharge channel 108, of which it's opening corresponds to the releasing space 105 between roller 103 and inside of the drum 102.

For feeding packages containing liquid product into the rotary press 101 an input channel 106 can be provided having an opening at its output side corresponding to the capturing space 104. The input channel 106 can be a tapered channel having a length/diameter ratio high enough to prevent released liquid product to spill out of the apparatus via input channel 106. The input channel 106 can alternatively be provided with a door to prevent spilling of liquid product from the rotary press 101.

The rotary press 101 can be provided with a panel 110 at a first end 121 of the rotary press 101 having the input channel 106. The panel 110 is attached to the support frame or mount. The panel 110 has a feed opening 118 corresponding to the output of the input channel 106. The panel 110 prevents liquid product released from the package to escape via the first end 121 of the rotary press 101. At an opposite end 120 of the rotary press, a hood 111 can be provided preventing released product from escaping via the opposite end 120 out of the rotary press 101. The hood is provided with a grid 122a to prevent solid particles in the released liquid product that may have been separated from the package such as caps or container parts to enter the liquid drain 107. The package discharge channel 108 communicates with releasing space 105 via an opening in the hood 111. The package discharge channel 108 may be integrated in the hood 111. The hood 111 is mounted to the support frame or mount.

At a bottom part of the package discharge channel 108, also a grid 122b can be provided allowing liquid product which had remained on the flattened package to fall of the package, which package is released through the package discharge channel 108 from the releasing space 105.

Any liquid product captured and drained from the rotatable drum via grid 122b can be collected in the liquid drain 107. The collected liquid product in drain 107 can now be further filtered to remove smaller particles and processed for disposal or recycling.

The capturing space 104 and the releasing space 105 are separated by means of the roller 103 and a baffle 109a placed between the outer surface of the roller 103 and inner surface of the rotatable drum 102 and extending from the first end 121 to the opposite end 120 of the rotary press 101. Any liquid product released from the package while being pressed in the capturing space 104 and spraying within the capturing space 104 will be contained by the baffle 109 while simultaneously pressed packages entering the releasing space 105 will be contained inside the releasing space 105 by the baffle 109. A guide 123 can be provided which guides packages containing liquid product from the opening 118 further into the capturing space 104, preferably substantially into a centre part of the capturing space, thereby preventing the package containing liquid product to pile up at the opposite end of the rotary press 101.

The hood 111 can be placed such that it allows space between the hood inner surface and the opposite end 120 of the rotary press 101. Within that space, the first baffle 109a can be extended up to the inner wall of the hood, while a second baffle 109b can be placed providing further separation between released packages and released liquid product. The second baffle 109b can be provided with a scraper 114 for scraping off any liquid product picked up by the roller side facing the inner surface of the hood 111.

FIG. 2 shows cross section of the apparatus for the separation of fluid from a package along the line A-A of FIG. 1.

FIG. 2 shows package with liquid product 201 captured between the roller 103 and the drum 102. FIG. 2 shows that the rotatable drum 102 has a lining 202, as well as the roller 103 has a lining 203. The lining 202, 203 can be made of resilient material such as rubber.

FIG. 2 also shows liquid product 205 released from the package 20 being maintained at the capturing space 104 of the rotary press 101. The liquid barrier formed by the contact line 116 keeps the liquid product 205 on the capturing space 104 side.

Packages with liquid product 201 are entered in to the capturing space 104 through opening 118. It is clear from FIG. 2 that packages inserted near the first baffle 109a will be transported by the roller 103 in a rotational direction 117 further into the space 104, while simultaneously flattened packages 204 are kept in the releasing space 105 by the same first baffle 109a, such packages are not allowed to pass by the first baffle 109a. In the releasing space 105 a flattened package 204 is shown.

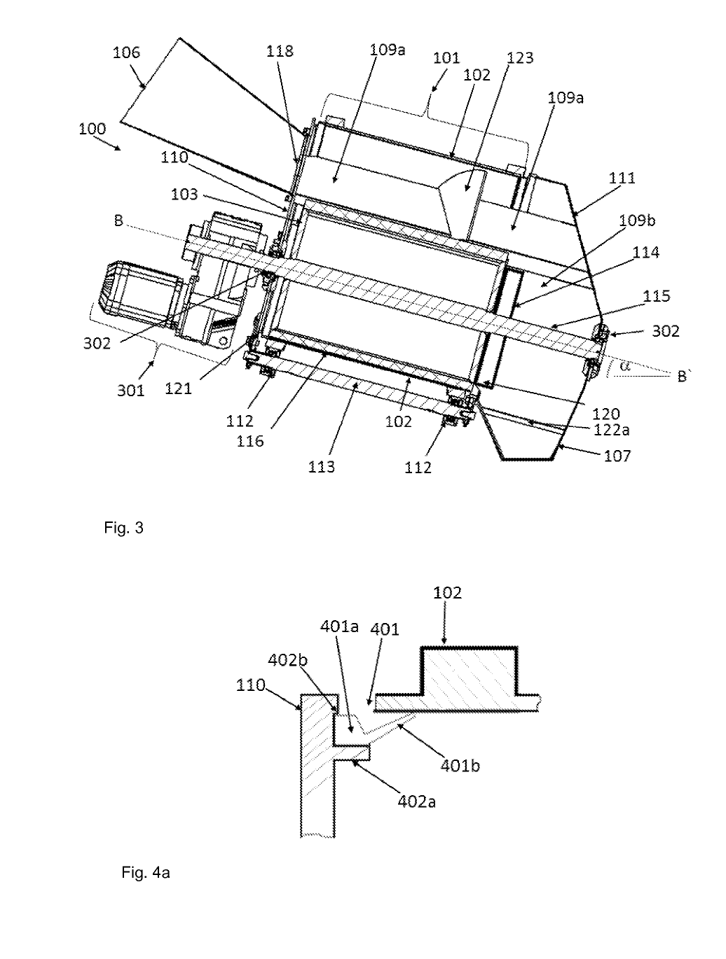

FIG. 3 shows a cross section in longitudinal direction along rotation axis B-B′ of the apparatus 100 according to the invention. A drive 301 is shown comprising an electric motor and a gear mounted on the axle 115 of the roller 103. The roller axle 115 is supported by bearings 302 in panel 110 and hood 111 respectively. Each bearing 302 is provided with a seal for preventing any leakage from inside the apparatus to the environment and vice versa, or from the lubricant of the bearing 302 into the apparatus and vice versa.

FIG. 3 further shows that the apparatus 100 can be tilted with an angle with respect to the horizontal plane. FIG. 3 further shows that the hood 111 forms a space at the lower end of the rotary press allowing liquid product to flow into drain 107 via grid 122a, the space created by the hood 111 is subdivided by the second baffle 109b in the plane of FIG. 3. Baffle 109b can be provided with a scraper 104 for scraping of any liquid product remaining on the lower side of the roller 103.

Not shown in FIG. 3 are spray heads which may be installed in various places within the hood and also within in the capturing space 104 and releasing space 105. These spray heads can be mounted in the hood 111 wall and/or in the panel 110. The spray heads can spray a cleansing agent into the various cavities within the apparatus 100 for cleansing.

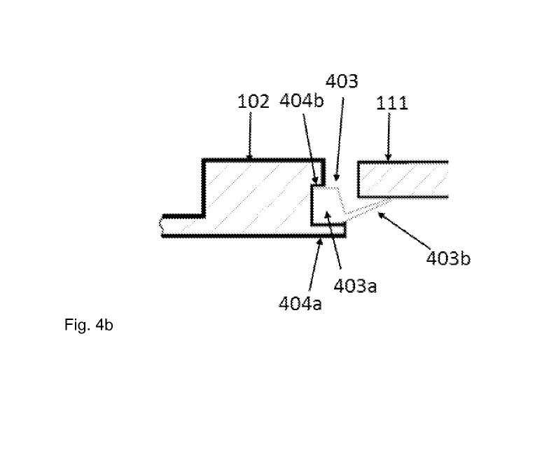

FIG. 4a shows a cross section of a detail of the apparatus according to an embodiment of the invention.

In order to maintain any liquid product within the confinement of the rotatable drum 102 a circular seal 401 is required between rotatable drum 102 and panel 110. The seal has base 401a and rim 401b, the seal rim 401b touches the inner surface of the rotatable drum 102.

The seal base is fixed with respect to the panel 110 by protrusion 402a and may additionally be fixed by an edge 402b to the panel 110 near an edge of the panel. The seal 401 allows the rotatable drum 102 to rotate while the panel 110 is stationary while any liquid product or particulars remain within the space behind by the inner side of the drum 102.

Likewise in FIG. 4b, a seal 403 is disposed between the rotatable drum 102 and an edge of the hood 111. Seal base 403a is fixed to an circular edge 404a facing the hood 111 while an additional circular edge 404b can provided further support for the sealed based 403a. Seal rim 403b touches the inner side of the hood 111 such that liquid product and or particular remain within the space combined by the inner side of the drum 102 and hood 111. As the interface between rotatable drum 102 and hood 111 is circular, the seal 403 is also circular like seal 401.

The above embodiment are describes by way of example only. They are not intended to limit the extent of protection as defined by the claims below.

### REFERENCE NUMERALS

100 Apparatus for separating product from a package
101 rotary press
102 rotatable drum
103 roller
104 capturing space
105 releasing space
106 input channel
107 liquid product drain
108 package discharge channel
109a first baffle
109b second baffle
110 panel
111 hood
112 support wheel
113 support axle
114 scraper
115 roller axle
116 contact line
117 rotation direction
118 feed opening
120 opposite end
121 first end
122a grid
122b grid
123 guide
201 package containing liquid product
202 rotatable drum lining
203 roller lining
204 flattened package
205 released liquid product
301 drive
302 bearings
401 seal
401a seal base
401b seal rim
402a protrusion
402b support edge
403 seal
403a seal base
403b seal rim
404a protrusion
404b support edge

What is claimed is:

1. An apparatus for separating liquid product from a package containing the liquid product, comprising:
a rotary press comprising a rotatable drum and an eccentrically placed roller at a lower part within the rotatable drum, the rotary press having a first end and an opposite end;
the rotary press has a capturing space between the rotary drum and the roller, being defined by a narrowing distance between a roller outer surface and a rotary drum inner surface in a rotation direction of the rotary press for receiving, capturing and pressing a package containing liquid product;
the rotary press has a releasing space between the rotary drum and the roller, being defined by a widening space between the roller outer surface and the rotary drum inner surface in the rotation direction of the rotary press for releasing the pressed package, and;
the roller and the rotatable drum are cooperatively positioned to form a liquid barrier at a contact line between the outer surface of the roller and the inner surface of the rotatable drum for preventing liquid product pressed from the package from flowing from the capturing space into the releasing space;
a first baffle placed between the roller and the rotatable drum for separating the capturing space and the releasing space;
a first cover located at the opposite end of the rotary press, having a first seal disposed between the rotatable drum and the first cover allowing the rotary press to rotate while the first cover is stationary; wherein
the first cover has a first output for allowing the liquid product to be drained from the capturing space from the rotary press, and a second output at the opposite end of the rotary press for allowing the package to be discharged from the releasing space.

2. The apparatus according to claim 1, further including a second cover at the first end of the press, having a second seal between the rotatable drum and the second cover allowing the rotary press to rotate while the second cover is stationary, wherein the second cover has an opening for allowing the package containing liquid product to be fed into the capturing space.

3. The apparatus according to claim 2, wherein the first and/or first cover are provided with spray heads for spraying a cleansing agent into the rotary press.

4. The apparatus according to claim 2, wherein the first baffle extends from the second cover to the first cover.

5. The apparatus according to claim 1, further comprising an input at the first end of the rotary press for feeding the package containing liquid product into the capturing space.

6. The apparatus according to claim 5, wherein the input comprises a funnel shaped channel.

7. The apparatus according to claim 1, further comprising a second baffle disposed in the first cover for separating the first and second output.

8. The apparatus according to claim 1, wherein the first baffle is provided with a scraper arranged for scraping liquid product from a side of the roller at the opposite end of the rotary press.

9. The apparatus according claim 1, further comprising a guide within the capturing space for guiding the package containing liquid product into the capturing space.

10. The apparatus according claim 1, wherein the rotary press is held at an angle (α) between a rotation axis (B-B′) of the rotary press and a horizontal plane, wherein the first end of the press is in a higher position relative to the horizontal plane than the opposite end.

11. The apparatus according to claim 1, further comprising a drive for driving at least one of the rotatable drum and the roller in the rotation direction.

12. The apparatus according to claim 11, wherein the drive is coupled to the roller with an axle.

13. The apparatus according to claim 12, wherein the axle extends through the second cover and first cover with respective third seals.

14. The apparatus according claim 1, wherein the outer surface of the roller and/or the inner surface of the rotatable drum is lined with a layer of resilient material.

15. The apparatus according to claim 14, wherein the resilient material is rubber.
